(19) United States
(12) Patent Application Publication
(10) Pub. No.: US 2007/0125435 A1
(43) Pub. Date: Jun. 7, 2007

(54) Method and apparatus for installing fluid system components

(76) Inventor: Michael L. Curtis, Madison, CT (US)

Correspondence Address: Philip J. Lee, Suite 525, 10050 Regency Circle, Omaha, NE, 68114, US

(21) Appl. No.: 11/606,472

(22) Filed: Nov. 30, 2006

Related U.S. Application Data
(60) Provisional application No. 60/741,312, filed on Dec. 1, 2005.

(51) Int. Cl. H01F 7/06; F15B 13/00; F16K 1/00

(52) U.S. Cl. 137/884; 29/606

(57) ABSTRACT

A method and apparatus for installing one or more axially ported components on a manifold with lateral space restraints, an installation bore being formed to have a sealing surface and the manifold further modified to include an outer threaded section, the apparatus including a sealing member formed of a compressible material with a central bore sized to receive a tubular port of a component to be installed, a drive sleeve having a slot extending through one side, an interior sized to receive the body of a component to be installed, and a threaded end, a thrust collar being positioned between the drive sleeve and sealing member, the formation of he installation bore, assembly of the sealing member, thrust collar and drive sleeve around the flow component to be installed and the engagement of the drive sleeve screw threads with the installation bore screw threads resulting in the compression of the sealing member causing the securing and sealing of the flow component and its port in the manifold.

### CROSS REFERENCE TO RELATED PROVISIONAL APPLICATION

This application claims the benefit of U.S. Provisional Application No. 60/741,312, filed Dec. 1, 2005.

### BACKGROUND OF THE INVENTION

A. Field of Invention

The present invention relates generally to methods and apparatus for installing fluid system components and more particularly to an apparatus and method of installing axially ported components in a boss or manifold.

B. Description of Related art

A variety of fluid systems require the connection of a valve or other axially ported component to a boss or manifold under conditions where removability and compact design are most desirable. Chemical analysis apparatus, for example, often require multiple valves arrayed within a small area, with the capability of controlling small amounts of reagent. Conventional installation methods include cementing the component in place, connecting a tube section between the component and the manifold, or securing a component receiving drive sleeve to the manifold. The process of cementing a component in place prevents easy removal or replacement of the cemented component without damage to the component or manifold. Displacing the component from the manifold and connecting the component to the manifold by a length of tubing allows multiple ports within a small area, but the length of tubing may change the operating characteristics of he system and requires filling the connecting tube with the fluid to be dispensed, which may be wasteful. Since most components used in such arrays are electrically powered and controlled, wires must be lead from the component to a control and/or power circuit and the wires are preferably attached before installation. Therefore, it is desirable to provide an installation system that would neither disturb the wires nor require their attachment after installation of the component. Conventional methods of securing a component receiving drive sleeve to the manifold may be relatively bulky and may cause leakage or unintended disengagement from the manifold. In complex systems involving small components, the components are susceptible to damage and an installation system would preferably provide protection of the components against otherwise damaging forces.

Therefore, there is a need for an improved method and device for sealingly and removably securing an axially ported component to a manifold under space limitations.

### SUMMARY OF THE INVENTION

The method of the present invention comprises installing an axially ported valve or other component with at least one tubular port axially extending from a component body using the apparatus described herein. A mounting opening is formed in the manifold with a section having a conically tapered wall with an inner end and an outer end that is of greater diameter than the inner end and forming an internally threaded section within the manifold opening. A sealing member is formed of an elastomeric substance such as PTFE with a frustaconically tapered outer surface corresponding to the tapered inner surface of the manifold opening and a central bore coaxial with the tapered outer surface. The tubular extension of the component port is inserted into the central bore of the sealing member and the sealing member is inserted in to the manifold opening and forcefully retained therein by the engagement of the threaded section of the manifold opening by external threads formed at one end of a generally cylindrical drive sleeve. A thrust bearing collar placed between the sealing member and the drive sleeve isolates the sealing member from direct frictional contact with the drive sleeve. The thrust collar comprises a flat annular upper surface with an opening in the center, and a circumferential rim that extends downward in the direction of the sealing member and an inward flange extending inward toward the center of the sealing member. The collar rim is cylindrical and surrounds a radially protruding lip around the upper edge of the sealing member, the sealing member lip being received within the collar rim and flange when the sealing member and collar are assembled together. The drive sleeve defines a central chamber of sufficient inside dimension to receive the body of a component to be installed. The threaded end of the drive sleeve has a opening that is of greater inside diameter than the sleeve chamber, forming an inward projecting and downward facing shoulder with a downward, flat drive surface that corresponds to and in use contacts the radially outer edge portion of the upper surface of the thrust bearing collar. The drive sleeve threaded end opening is of sufficient inside diameter to receive the collar rim within the opening. The drive sleeve has a drive surface at the end opposite from the threaded end and comprises a slot extending axially from the threaded end to the drive end. The drive end of the drive sleeve has an outer surface adapted to be engaged and securely gripped by a tool for applying rotational force to the sleeve, for example, the illustrated drive end is hexagonal in cross section to be easily engaged by a wrench or other drive tool means for imparting rotational force to the drive sleeve. The upper end of the drive sleeve is open to the sleeve chamber and the opening of the upper end is of lesser diameter that the sleeve chamber and the component to be installed. At least the upper surface of the collar is preferably formed of a metal and the opposing surfaces of the drive sleeve and thrust collar are smooth to minimize friction between the opposing surfaces caused by rotation of the drive sleeve under pressure resulting from compression of the sealing member.

The sealing member and thrust collar may be assembled together before use and insertion into the installation bore. The thrust collar is placed over the sealing member and the lip of the upper portion of the sealing member is inserted within the thrust collar rim and inward extending flange, thereby retaining the thrust collar and sealing member together. The component to be installed in the manifold is either is placed within the drive sleeve before insertion of the port into the sealing member central bore or the drive sleeve may be placed over and around the component after the port has been inserted into the sealing member central bore. The longitudinally extending slot allows the drive sleeve to be placed over the component even after the component is in place and/or has been connected by electrical wiring and/or fluid supply tubing, since electrical control wires and/or input tubing can pass through the slot. The application of rotational force on the drive sleeve and the engagement of the sleeve screw threads with the screw threads of the installation bore causes forceful axial movement of the drive sleeve toward the manifold and thereby exerts axial pressure on the thrust collar without exerting axial pressure or force on the component, which is not directly secured to the drive sleeve. The pressure of the drive sleeve on the thrust collar compresses the sealing member causing the sealing member outer surface to seal against the tapered surface of the installation bore. The compression of the sealing member against the tapered surface of the installation bore imparts a radial inward compression of the sealing member causing the inner wall of the central bore to seal against the component port inserted therein. The drive sleeve, being screwed into the manifold provides support and protection to the installed component and since the opening of the drive end of the sleeve is smaller that the component body, the component is retained within the sleeve and secured to the manifold without being forced into position.

The principle aim of the present invention is to provide a new and improved method and device that meets the foregoing requirements and is capable of providing an efficient and compact installation of a component in a manifold.

Other objects and advantages of the invention will become apparent from the Description of the Preferred Embodiments and the Drawings and will be in part pointed out in more detail hereinafter.

The invention consists in the features of construction, combination of elements and arrangement of parts exemplified in the construction and method as hereinafter described.

### BRIEF DESCRIPTION OF THE DRAWINGS

FIG. 1 is a diagram of the assembly steps 1A, 1B, 1C, 1D, and 1E of the method of the present invention, showing a side view of an apparatus in accord with the present invention.

FIG. 2 is an enlarged cross sectional view of a component installed in a manifold section by means of the method and apparatus in accord with the present invention.

FIG. 3 is an enlarged side view of a drive sleeve of a preferred embodiment of an apparatus in accord with the present invention.

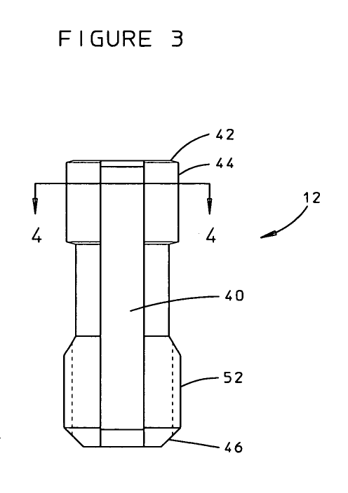

FIG. 4 is an enlarged top view of a drive sleeve of a preferred embodiment of an apparatus in accord with the present invention.

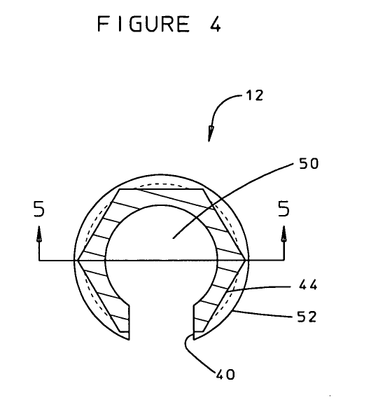

FIG. 5 is an enlarged cross longitudinal section view of a drive sleeve member of a preferred embodiment of an apparatus in accord with the present invention taken along line 5-5 shown in FIG. 4.

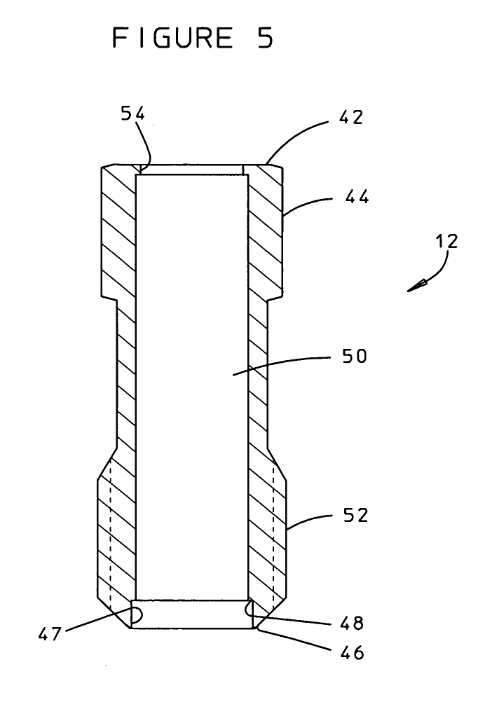

FIG. 6 is an enlarged cross sectional view of a sealing member of a preferred embodiment of an apparatus in accord with the present invention.

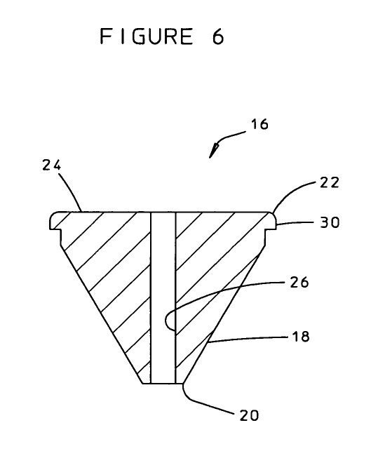

FIG. 7 is an enlarged cross section view of a thrust bearing collar assembled with a sealing member of a preferred embodiment of an apparatus in accord with the present invention.

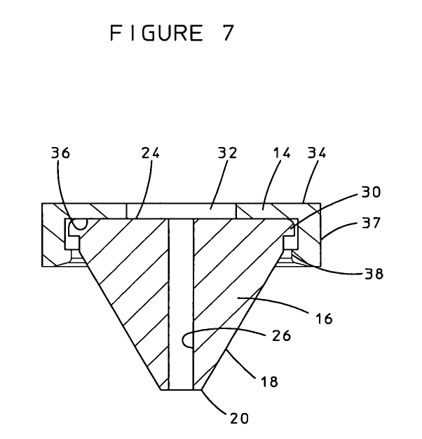

### DESCRIPTION OF THE PREFERRED EMBODIMENT(S)

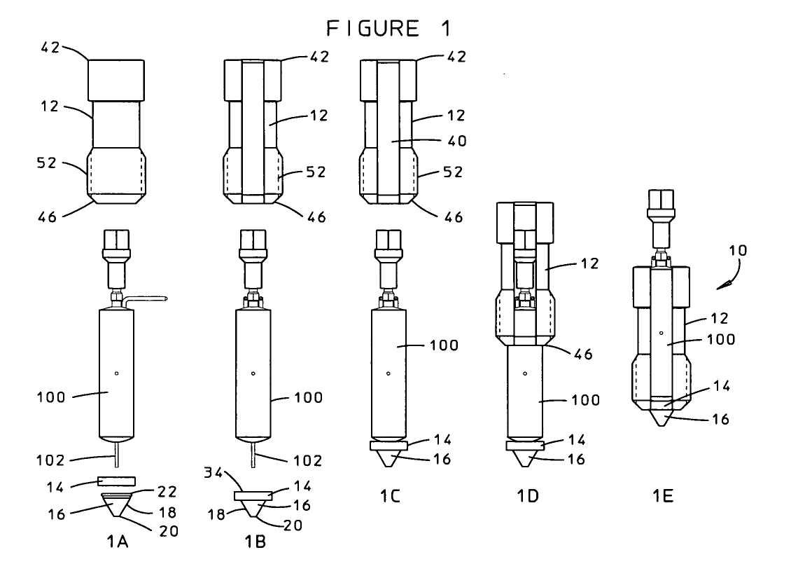

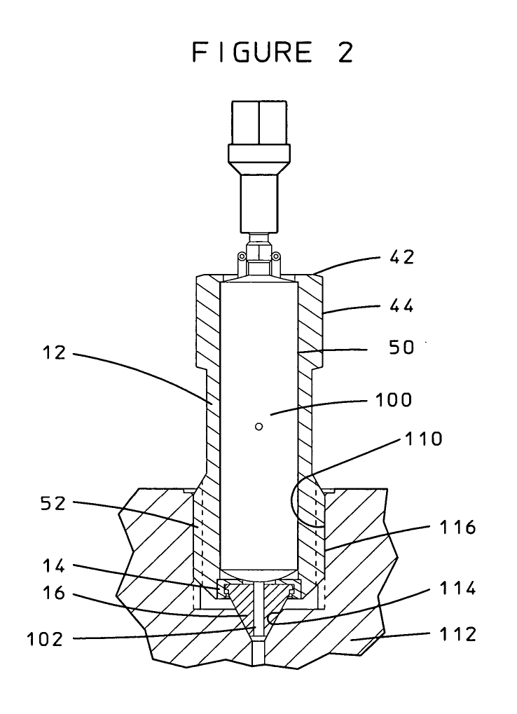

With reference to the Figures wherein like numerals represent like parts, a first preferred embodiment of an apparatus constructed in accordance with and for use in performing the method of the present invention is generally designated by numeral 10 in FIGS. 1 and 2. Apparatus 10 is illustrated with the component port to be installed in the manifold referred to as being at the bottom merely for ease of reference so that relative directions such as upper and lower, can be used in the description, and no limitation of the direction of installation is intended by such reference. Apparatus 10 comprises a generally cylindrical drive sleeve 12, a thrust bearing collar 14 and a sealing member 16. A typical axial component, which could be a valve, pump, pressure transducer, or a non-flow related component such as a sensor, is shown in FIGS. 1 and 2 and designated by the numeral 100. Apparatus 10 is designed to function in conjunction with an installation bore which may be formed in a manifold, which may, but need not, include installations of a multitude of other components, all or some of which may be installed by the present method using apparatus 10. Apparatus 10 is intended to be used to install a component in an installation bore formed in the manifold with a tapered inner surface and a threaded section. A typical installation bore is illustrated in FIG. 2 and designated by the numeral 110 with a section of manifold 112, a tapered section 114 and a threaded section 116.

Sealing member 16 is preferably formed of polytetrafluoroethylene, commonly referred to as PTFE, commonly available and sold under the trademark Teflon, registered to E. I. du Pont de Nemours and Company or its affiliates, for the benefit of the generally chemically inert nature of the material as well as its physical characteristics, specifically compressibility. It will be appreciated that sealing member 16 can be formed of other suitable material including more reactive materials if inertness is not a necessary trait, provided that the material used is at least somewhat compressible. The illustrated preferred embodiment of sealing member 16 is generally conical with a central bore 26 sized to receive the tubular port 102 of an axial flow component such as component 100. The outer surface 18 of sealing member 16 conically tapers from a relatively narrower end 20 to a wider end 22 at an angle of about 55 to 65 degrees. Wider sealing member end 22 comprises a flat disc shaped surface 24 normal to the axis of the sealing member 16 and sealing member central bore 26. Adjacent to wider end 22, the outer diameter of the surface of sealing member 16 is reduced, forming an annular circumferential lip 30 extending radially outward and continuous with surface 24.

Thrust bearing collar 14 is annular, having a central opening 32 a flat annular surface 34 on one side and a sealing member engaging side 36 on the other side. Sealing member engaging side 36 comprises a circumferential downwardly projecting rim 37 projecting in the direction of away from surface 34 and toward sealing member narrower end 20 in the assembled apparatus 10. Rim 37 extends from the outer edge of side 36 to an annular flange 38. Sealing member engaging side 36 is of a diameter equal or slightly greater than the diameter of wider end 22 such that rim 37 can surround sealing member wider end 22 and lip 30. Flange 38 projects inwardly and is generally of a thickness and depth and is distanced from side 36 sufficiently to allow sealing member lip 30 to be received in the space between flange 38 and side 36. The outer diameter of collar 14 is greater that the diameter of the flow component 100 intended to be installed. Collar 14 is preferably formed of metal, with possible substitute materials selected for requisite rigidity and strength, if necessary.

Drive sleeve 12 is generally tubular in shape with a slot 40 extending the length of one side. Drive sleeve 12 comprises a first end 46 with a externally threaded outer surface 52 and a second end 42 with an adjacent outer surface 44. Drive sleeve 12 is open at both ends 42 and 46 and partially encloses a central chamber 50, the open ends 46 and chamber 50 being large enough to receive flow component 100 without binding and the opening 54 at end 42 being restricted to less than the diameter of the component 100 to be installed. The opening at first end 46 is formed with an inside wall 47 of greater inside diameter than chamber 50, and a shoulder is formed between wall 47 and the chamber 50 with a generally flat and annular surface 48 normal to the axis of sleeve 12. Inside wall 47 is of slightly greater diameter than collar rim 37 such that, in the assembled apparatus 10, collar 14 fits at least partially within wall 47 of end 46 and the outer edge of collar side 34 engages surface 48. Drive sleeve 12 is preferably of at least slightly less length that the separation between the port 102 and any side mounted electrical connections or other ports on the component to be installed, such that drive sleeve 12 is able to rotate about component 100 on installation. Outer surface 44 of sleeve second end 42 is circumferentially hexagonal in shape to readily accept a wench.

The method of the present invention comprises installing a component 100 in a manifold using an assembled apparatus 10, partially shown as section 112 in FIG. 2. First, an installation bore such as bore 110 is formed in the manifold using well known drilling and thread tapping techniques, so that the installation bore 110 has a tapered section 114 and a section 116 with internal screw threads. Next, as illustrated in part 1A of FIG. 1, a sealing member formed of compressible material similar to sealing member 16, a thrust bearing collar similar to collar collar 14 and a drive sleeve similar to sleeve 12 are formed or selected from preformed members, such that the sealing member has a central bore of a size to receive the port 102 of component 100, the sleeve has a central chamber sufficient to receive the body section of a component 100, and the selected thrust bearing collar fits over the lip of the sealing member collar. Then the sealing member 16 and collar 14 are assembled by pressing the wide end lip 30 of sealing member 16 into the space defined by side 36 of collar 14, collar rim 37 and collar flange 38, such that the sealing member lip 30 is retained within the collar flange 38, as illustrated in part 1B of FIG. 1. The component port 102 is then inserted through the thrust bearing collar central opening 32 and into the sealing member bore 26, as illustrated in part 1C of FIG. 1. The body of component 100 is then inserted into chamber 50 of drive sleeve 12 through sleeve first end 46 as illustrated in part 1D of FIG. 1 until the collar rim 37 is within the inside wall 47 of sleeve end 46 and drive sleeve normal surface 48 contacts bearing side 34 of collar 14, as illustrated in part 1E of FIG. 1. Then the assembled sealing member 16, thrust collar 14 and component port 102 are inserted into the tapered section 114 of the manifold 112. Finally, engagement of the drive sleeve threaded section 52 within the threaded section 116 of the installation bore 110 and the rotation of drive sleeve 12 advances apparatus 10 and component 100 within installation bore 110, as illustrated in FIG. 2. The forcible contact of drive sleeve surface 48 with thrust collar surface 34 caused by sufficient rotational torque applied to drive sleeve 12 causes collar 14 to compress sealing member tapered surface 18 against installation bore tapered section 114, which results in the narrowing of sealing member central bore 26 thereby constricting about component port 102. In this manner, the component 100 is sealed and secured to the manifold without direct exertion of axial force on the component.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention. It will be anticipated that the drive sleeve screw threads could be internal if the screw threads of the installation bore were external. Similarly, the shape of the sealing member could be varied with results varying according to the shape used and the drive surface of sleeve second end 42 could be modified to include a knurled or splined surface for engaging a rotational tool. In addition, apparatus 10 can be assembled before insertion of component 100, which can be inserted through sleeve end 42, and collar 14 can be retained within sleeve 12 if desired for convenience of installation.

I claim:

1. A method of installing a component having a body and at least one port to be installed in a manifold, the method comprising
forming an installation bore in the manifold with a tapered section and a section with screw threads and
inserting the component port into a central bore formed in a sealing member formed of a compressible material and
inserting the component body into a drive sleeve with a central bore having a diameter at least as great as the outside diameter of the component body and having at a first end screw threads corresponding to the screw threads of the installation bore, and
compressing the sealing member between the tapered section of the manifold opening and a threaded drive sleeve by engaging of the screw threads of the drive sleeve with the screw threads of the manifold opening and rotating the drive sleeve relative to the installation bore.

2. The method of claim 1, further comprising the step of interposing an annular collar between the sealing member and the drive sleeve.

3. The method of claim 2, further comprising inserting the component body into a drive sleeve having slot in the wall of the sleeve central bore extending from the first end to a second end.

4. The method of claim 3, further comprising inserting the component body into a drive sleeve having a surface at the end adapted to fit a tool for imparting rotational force to the sleeve.

5. The method of claim 4, further comprising inserting the component body into a drive sleeve having external screw threads at the first end.

6. The method of claim 5, further comprising the step of securing a tool to the drive sleeve second end and imparting rotational force to the drive sleeve by manipulation of the tool.

7. The method of claim 6, wherein the surface of the drive sleeve second end is formed with a hexagonal circumference.

8. An apparatus for installing a component having a body and at least one tubular port to be installed in an opening in a manifold having a tapered section with a larger diameter toward the outside of the manifold, and a threaded section, the apparatus comprising
a compressible sealing member having an outer surface corresponding to the tapered section of the manifold opening, and a central bore of sufficient diameter to allow insertion of the component port into the sealing member bore, and
a generally cylindrical drive sleeve having a threaded section corresponding to and engageable with the threaded section of the manifold opening, and a first end surface with a central opening and a second drive end, and
a flat annular disc with a central opening and a surface corresponding to and in contact with the drive sleeve end surface and an opposing surface in contact with the sealing member.

9. The apparatus of claim 8, wherein the sealing member outer surface is frustaconical in shape and is coaxial with the sealing member bore.

10. The apparatus of claim 9, wherein the drive sleeve surrounds an interior volume sufficient to receive the body of the component to be installed.

11. The apparatus of claim 10, wherein the drive end of the drive sleeve further comprises a central opening and an outer surface adapted to receive a tool for imparting rotational force to the sleeve.
